(19) United States
(12) Patent Application Publication
(10) Pub. No.: US 2023/0117535 A1
(43) Pub. Date: Apr. 20, 2023

(54) METHOD AND SYSTEM FOR DEVICE FEATURE ANALYSIS TO IMPROVE USER EXPERIENCE

(71) Applicant: SAMSUNG ELECTRONICS CO., LTD., Suwon-si (KR)

(72) Inventors: Vijendra Raj Apsingekar, San Jose, CA (US); Myungjong Kim, San Jose, CA (US); Anil Yadav, Santa Clara, CA (US)

(21) Appl. No.: 17/502,838

(22) Filed: Oct. 15, 2021

(51) Int. Cl. G10L 15/02; G10L 25/30; G06F 40/279; G10L 15/26

(52) U.S. Cl. CPC G10L 15/02; G10L 25/30; G06F 40/279; G10L 15/26

(57) ABSTRACT

A method and system are provided. The method includes receiving an audio input, in response to the audio input being unrecognized by an audio recognition model, identifying contextual information, determining whether the contextual information corresponds to the audio input, and in response to determining that the contextual information corresponds to the audio input, causing training of a neural network associated with the audio recognition model based on the contextual information and the audio input.

### BACKGROUND

### 1. Field

The disclosure relates to a system and method for improving performance of voice assistance applications.

### 2. Description of Related Art

Voice assistance applications rely on automatic speech recognition (ASR). The voice assistant may misrecognize a user's utterance when the user has an accent, the user is in a noisy environment, the utterance contains proper nouns, such as specific names, etc. To adapt the misrecognized utterance, a person may be involved to manually transcribe the utterance. However, the manual transcription is costly and time consuming, and therefore adaption of the voice assistance application may be expensive and delayed.

### SUMMARY

Additional aspects will be set forth in part in the description that follows and, in part, will be apparent from the description, or may be learned by practice of the presented embodiments of the disclosure.

In accordance with an aspect of the disclosure, a method may include receiving an audio input, in response to the audio input being unrecognized by an audio recognition model, identifying contextual information, determining whether the contextual information corresponds to the audio input, and in response to determining that the contextual information corresponds to the audio input, causing training of a neural network associated with the audio recognition model based on the contextual information and the audio input.

In accordance with an aspect of the disclosure, a system may include a processor and a memory storing instructions that, when executed, cause the processor to receive an audio input, in response to the audio input being unrecognized by an audio recognition model, identify contextual information, determine whether the contextual information corresponds to the audio input, and in response to determining that the contextual information corresponds to the audio input, cause training of a neural network associated with the audio recognition model based on the contextual information and the audio input.

### BRIEF DESCRIPTION OF THE DRAWINGS

The above and other aspects, features, and aspects of embodiments of the disclosure will be more apparent from the following description taken in conjunction with the accompanying drawings, in which:

FIG. 1 is a diagram of a system for analyzing contextual information according to an embodiment;

FIG. 2 is a diagram of components of the devices of FIG. 1 according to an embodiment;

FIG. 3 is a diagram of a system for analyzing contextual information according to an embodiment;

FIG. 4 is a diagram of a server device for analyzing contextual information, according to an embodiment; and

FIG. 5 is a flowchart for a method of analyzing contextual information according to an embodiment.

### DETAILED DESCRIPTION

The following detailed description of example embodiments refers to the accompanying drawings. The same reference numbers in different drawings may identify the same or similar elements.

Example embodiments of the present disclosure are directed to improving audio recognition models. The system may include a user device and a server device. The user device may receive a user utterance as an audio input, and the audio recognition model may not recognize the audio input. When the audio recognition model does not recognize the audio input, the user may utilize other applications, such as a browser application, map application, text application, etc., to compensate for the non-recognition by the audio recognition model. The user device may obtain information contextual to activity of the user before, during, or after the unrecognized audio input occurs and then transmits this information to a server device. The server device may analyze the contextual information to determine whether the information is correlated with the unrecognized audio input, and then may train a neural network associated with the audio recognition model based on the contextual information when the information is correlated with the unrecognized audio input.

By identifying contextual information when an audio input is unrecognized by the audio recognition model, and training a neural network associated with the audio recognition model when the contextual information corresponds to the unrecognized audio input, the audio recognition model can be updated to recognize more terms as an audio input, thereby improving the functionality of the audio recognition models (i.e., actively adapting to new inputs and increasing the range of recognized input) as well as the functionality of the devices implementing the audio recognition models (i.e., mobile devices or other computing devices function with increased speed and accessibility with improvements to the audio recognition model).

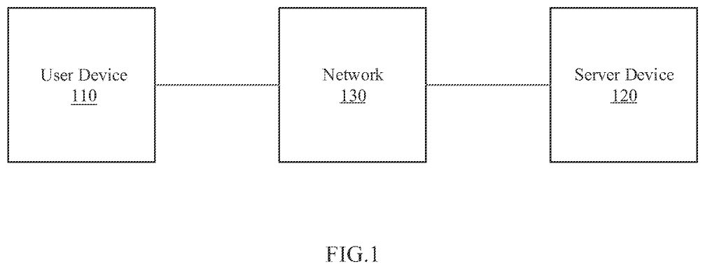

FIG. 1 is a diagram of a system for analyzing contextual information according to an embodiment. FIG. 1 includes a user device 110, a server device 120, and a network 130. The user device 110 and the server device 120 may interconnect via wired connections, wireless connections, or a combination of wired and wireless connections.

The user device 110 may include a computing device (e.g., a desktop computer, a laptop computer, a tablet computer, a handheld computer, a smart speaker, a server device, etc.), a mobile phone (e.g., a smart phone, a radiotelephone, etc.), a camera device, a wearable device (e.g., a pair of smart glasses or a smart watch), or a similar device.

The server device 120 includes one or more devices. For example, the server device 120 may be a server device, a computing device, or the like.

The network 130 includes one or more wired and/or wireless networks. For example, network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) may perform one or more functions described as being performed by another set of devices.

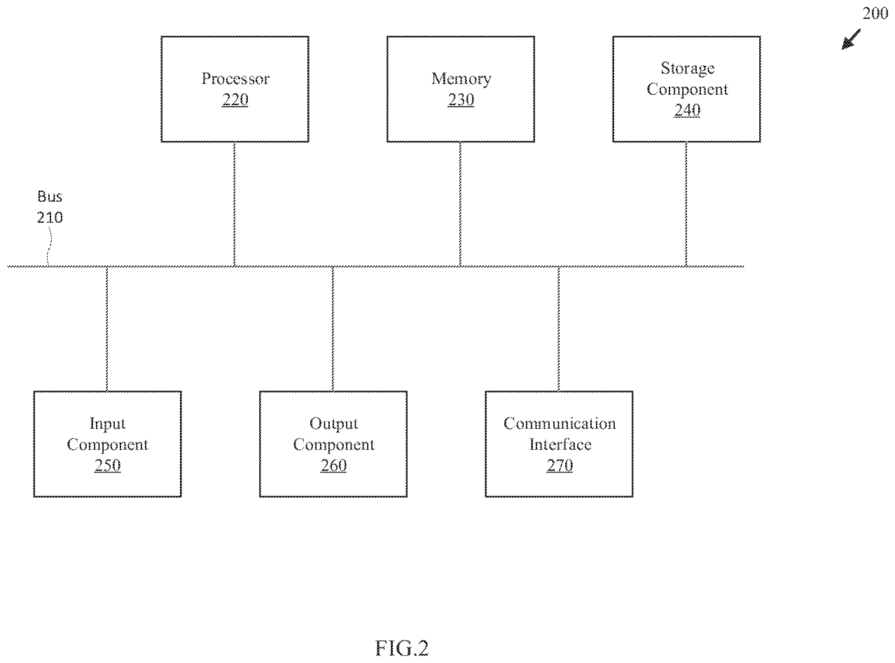

FIG. 2 is a diagram of components of one or more devices of FIG. 1 according to an embodiment. Device 200 may correspond to the user device 110 and/or the server device 120.

As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor 220 includes one or more processors capable of being programmed to perform a function.

The memory 230 includes a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g., a touch screen display, a keyboard, a keypad, a mouse, a button, a switch, and/or a microphone). The input component 250 may include a sensor for sensing information (e.g., a global positioning system (GPS) component, an accelerometer, a gyroscope, and/or an actuator).

The output component 260 includes a component that provides output information from the device 200 (e.g., a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform operations based on the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or storage component 240 may cause the processor 220 to perform one or more processes described herein.

Additionally, or alternatively, hardwired circuitry may be used in place of or in combination with software instructions to perform one or more processes described herein. Thus, embodiments described herein are not limited to any specific combination of hardware circuitry and software.

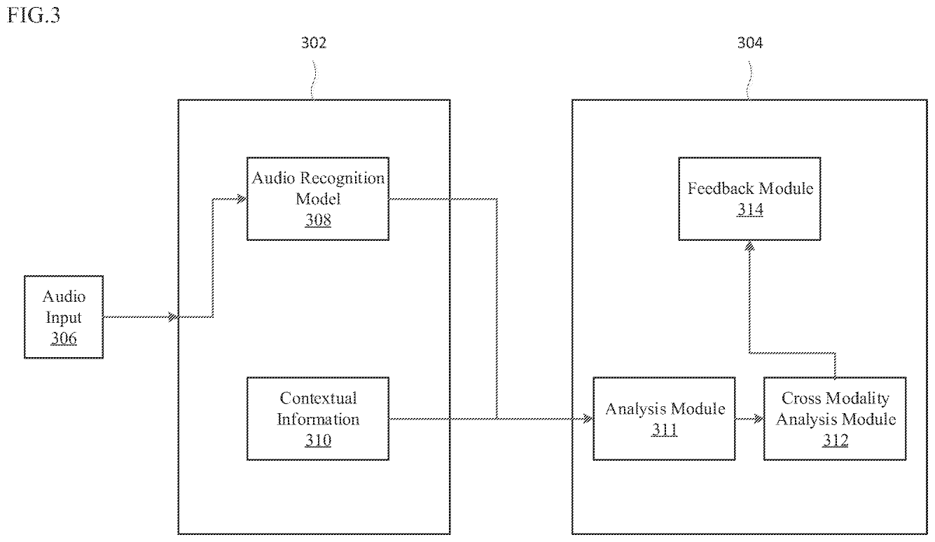

FIG. 3 is a diagram of a system for analyzing contextual information according to an embodiment. The system includes a user device 302 and a server device 304. The user device 302 includes an audio recognition model 308 and a contextual information identifier 310. Alternatively or additionally, the server device 304 may include an audio recognition model configured to transcribe audio received from the user device 302 (i.e., the user device 302 receives an audio input and then transmits the audio input to the server device 304 to be processed). The server device 304 may also include a contextual information identifier. The server device 304 includes an analysis module 311, a cross modality analysis module 312 and a feedback module 314. The user device 302 may receive an audio input 306. When the audio recognition model 308 does not recognize the audio input 306, the contextual information identifier 310 may identify contextual information, such as visual information, audio information, textual information, etc., that is contemporaneous to the unrecognized audio input. The user device 302 may send the unrecognized audio input as well as the identified contextual information to the server device 304. The unrecognized audio input may be converted into a textual input.

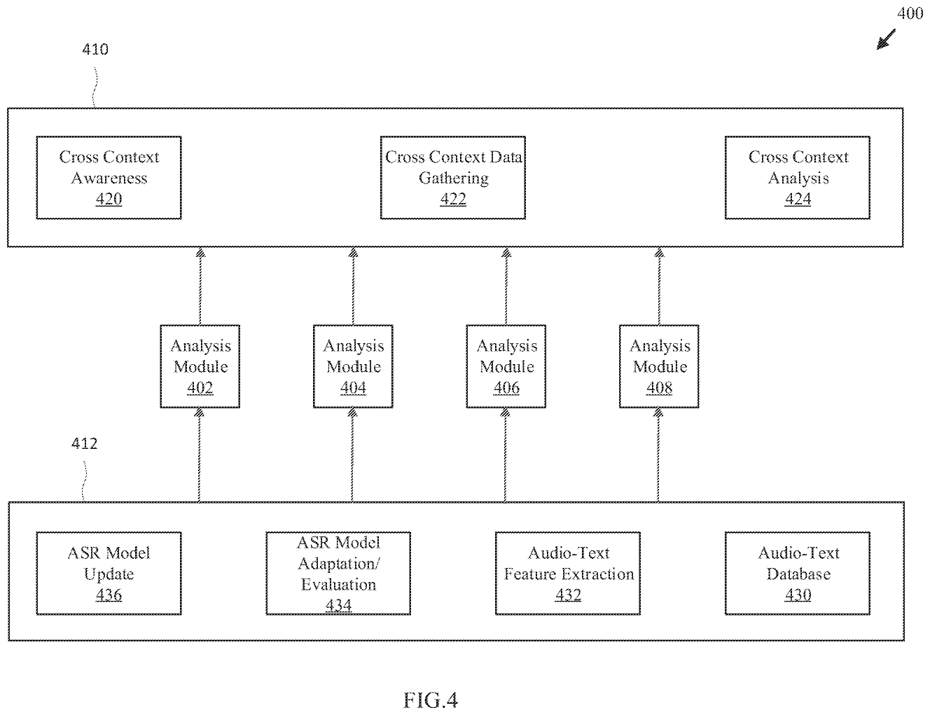

The server device 304, via the analysis module 311, may analyze the received contextual information to extract textual information, normalize textual information, or otherwise format the contextual information (e.g., format audio into text) so that it can be analyzed by the cross modality analysis module 312. As described and depicted in FIG. 4 below, the analysis module 311 may include a plurality of analysis modules configured based on input type. The cross modality analysis module 312 may determine if two or more seemingly independent events that a user performed are related. When the cross modality analysis module 312 determines, based on the contextual information from the analysis module 311, that the contextual information correlates with the unrecognized audio input, the cross modality analysis module 312 may generate cross-context data and send the cross-context data to the feedback module 314. The feedback module 314 may store the cross-context data, prepare the cross-context data for updating the analysis module 311, train the analysis module 311 based on the cross-context data, train a neural network associated with the audio recognition model 308, and update the audio recognition model 308 based on the trained neural network.

FIG. 4 is a diagram of a server device 400 for analyzing contextual information according to an embodiment. The server device 400 includes a plurality of analysis modules 402, 404, 406 and 408, a cross modality analysis module 410 and a feedback module 412. The server device 400 may be connected to at least one user device.

The analysis modules 402-408 may be configured to analyze contextual information received from a user device. The contextual information may be visual information, audio information, textual information, etc. For example, the contextual information may be information identified to be contemporaneous with an unrecognized audio input, such as information from a web browser, information from a contacts list, information from a messaging application, audio output from a text to speech (TTS) function, and/or other types of information that can be obtained from a user device (e.g., a mobile terminal). The analysis modules 402-408 may be configured to convert audio contextual information into text (e.g., via an ASR model). The analysis modules 402-408 may be configured to normalize the contextual information. For example, if the contextual information received includes a number, the analysis modules 402-408 may be configured to convert the number into a word text (e.g., converting a received text of “20” into the text “twenty”). Furthermore, each analysis module 402-408 may be configured based on input type. For example, analysis module 402 may be an audio analysis module configured to analyze audio inputs, analysis module 404 may be a textual analysis module configured to analyze textual inputs and perform text extraction/normalization, etc. By separating the analyzed data by type and specific analysis module, the efficiency of the system can be improved. In addition, each analysis module 402-408 may be configured to receive any data type. The analysis modules 402-408 may send the converted/normalized contextual information to the cross modality analysis module 410.

The cross modality analysis module 410 may include a cross context awareness block 420, a cross context data gathering block 422 and a cross context analysis block 424. The cross context awareness block 420 may detect which modalities (e.g., text, audio, or other categories of contextual information) may be used for cross modality analysis. The cross-context awareness block 420 may be configured to narrow down possibly related cross modality events from a number of events recorded by a mobile device or a server device to identify candidate pairs of contextual information. For example, cross modality analysis module 410 may identify candidate utterance-text pairs by identifying text data input by a user within a predetermined time (e.g., one minute) of an utterance. After these candidate utterance/textual pairs are identified, the cross modality analysis module 410 can identify related utterance/textual pairs from the set of candidate pairs, for example, by determining intent similarity measures (e.g., edit distance) for the candidate pairs, as described more fully herein.

The cross context data gathering block 422 may perform data gathering from the detected modalities. The cross context analysis block 424 may perform cross modality analysis using data from the detected modalities. Although the cross modality analysis module 410 is depicted as having multiple blocks, this is exemplary and not exclusive, and the overall functionality of the cross modality analysis module 410 is described below.

The cross modality analysis module 410 may determine whether the contextual information corresponds to the unrecognized audio input. The cross modality analysis module 410 may determine related events. As a general example, if the unrecognized audio input is “who is the president?,” and the contextual information includes a web search on “who is the president?,” then the cross modality analysis module 410 may determine that the unrecognized audio input corresponds to the contextual information. On the contrary, if the contextual information includes a search for a friend in a contacts list, the cross modality analysis module may determine that the contextual information does not correspond to the unrecognized audio input.

The cross modality analysis module 410 may determine that the unrecognized audio input corresponds to the contextual information when the contextual information is obtained within a predetermined amount of time from when the audio input is received, or from when the audio recognition model of the user device provides an indication that the audio input is unrecognized. For example, the cross modality analysis module 410 may determine that the contextual information corresponds to the unrecognized audio input when the contextual information (e.g., text input data) is received within a predetermined amount of time from when a TTS function of the audio recognition model response to the audio input in the negative (e.g., says “I don't understand”, the ASR's probability or confidence score of the recognized results are less than a predetermined threshold, indicating the audio input is unrecognized, etc.). The predetermined amount of time between the indication that the audio input is unrecognized and the inputting of the contextual information may be determined based on a focus of accuracy (i.e., shorter time periods) or based on a focus of obtaining a greater amount of information (i.e., longer time periods).

The cross modality analysis module 410 may determine a similarity score between the unrecognized audio input and the contextual information. If the similarity score is greater than a pre-defined threshold, the cross modality analysis module 410 may determine that they are related events and may store the unrecognized audio input and contextual information on the server device 412 as cross-context data. If multiple unrecognized audio input and contextual information pairs have a similarity score greater than the predefined threshold, the cross modality analysis module 410 may select the pair with the highest similarity score to store in the server device 402 as cross-context data. If the similarity score is less than the predetermined threshold, the cross modality analysis module 410 may determine the pair is unrelated.

The cross modality analysis module 410 may determine an edit distance similarity score between the unrecognized audio input and the contextual information. The edit distance (e.g., Levenshtein distance) may refer to a way of quantifying how dissimilar two strings (e.g., character sequences) are to one another by counting a minimum number of operations required to transform one string to the other. The transform may allow deletion, insertion and substitution. For example, the edit distance between “noneteen” (i.e., the unrecognized audio input) and “nineteen” (i.e., the contextual information) is 1, as the number of substitutions is 1 (the “o” in “noneteen” can be substituted with “i” to match the strings), whereas the edit distance between “none” (i.e., the unrecognized audio input) and “nineteen” (i.e., the contextual information) is 5 (the “o” in “none” can be substituted with “i”, and then “teen” can be added to “nine” to match the strings, which is 1 substitution and 4 additions). The similarity score may be determined as in Equation (1).

Score(s1,s2)=(total number of characters−Edit distance(s1,s2))/total number of characters (1)

where s1 and s2 are string 1 and string 2, respectively. The total number of characters may be calculated based on string 1 (i.e., the ASR output). In the above example, “noneteen” has a total number of characters of 8. The edit distance of “noneteen” to “nineteen” is 1. Therefore, the similarity score may be, as in Equation (2).

Score(noneteen,nineteen)=(8−1)/8 (2)

Therefore, the similarity score of (noneteen, nineteen) is 0.875. When the edit distance similarity score is greater than an edit distance score threshold, the cross modality analysis module 410 may determine that the unrecognized audio input corresponds to the contextual information and store the pair in the server device 412 as cross-context data.

The edit distance score threshold may be determined based on prior similarity scores for similar inputs. The edit distance score threshold may also be determined based on a distribution of similarity scores on correct labels and misrecognized utterances (i.e., misrecognized ASR outputs). In addition, the edit distance score threshold may be determined based on a type of utterance and historical data regarding the type of utterance. For example, when considering a “who is someone” type of utterance, the system may determine that a percentage (e.g., 50%) of “who is someone” type utterances have a similarity score over a score value, such as 0.9 or any other score value that would indicate a high similarity. Therefore, when analyzing a “who is someone” type utterance, the system may determine the edit distance score threshold to be 0.9. The system may define an overall edit distance score threshold irrespective of the type of utterance.

While the example above describes using edit distance, this disclosure contemplates that other intent similarity measures may be used to determine the similarity between an utterance and contextual information. For example, the cross modality analysis module 410 may utilize a machine-learning-based similarity measure (e.g., neural network) to determine similarity, as well as an intent similarity measure. Intent similarity between an utterance and contextual information may be used to determine an ASR output contextual similarly. Moreover, more than one intent similarity measure may be used to determine the similarity between an utterance and contextual information. As one example, the cross modality analysis module 410 may use a machine-learning-based similarity measure and an edit distance similarity measure to determine the similarity between an utterance and contextual information.

The cross modality analysis module 410 may identify templates, or predefined structured sentences, in the unrecognized audio input and/or the contextual information, and remove the identified template from the character strings to further assist in determining whether the unrecognized audio input corresponds to the contextual information. For example, if a user inputs a search query such as “what is route 19?” the cross modality analysis module 410 may identify the string of “what is” as a template, and remove “what is” or omit “what is” from the comparison analysis. Other examples of templates may include commands (e.g., “play”, “call”, “open”, etc.), interrogatories (e.g., “who”, “what”, “where”, etc.) and other words as will be understood by those of skill in the art from the description herein.

The feedback module 412 may include an audio-text database 430, an audio-text feature extraction block 432, an ASR model adaptation/evaluation block 434, and an ASR model update block 436. The audio-text database 430 may be configured to store the cross-context data determined by the cross modality analysis module 410. The audio-text feature extraction block 432 may extract features (i.e., acoustic or textual features) from the cross-context data for subsequent training of neural networks associated with the analysis modules 402-408, and the audio recognition model of the user device. The ASR model adaptation/evaluation block 434 may determine parameters of the ASR model to be updated based on the cross-context data and the features extracted from the cross-context data, and then train the ASR model based on the determined parameters and extracted features. The ASR model adaptation/evaluation block 434 may also determine whether updating the parameters would degrade the effectiveness of the current ASR model, and only update the ASR model when it is determined that the effectiveness of the ASR model will not degrade past a predetermined degradation threshold. The ASR model update block 436 updates the ASR model with the newly trained ASR model. The newly trained audio analysis module (i.e., the ASR model) may be deployed to the user device following the training.

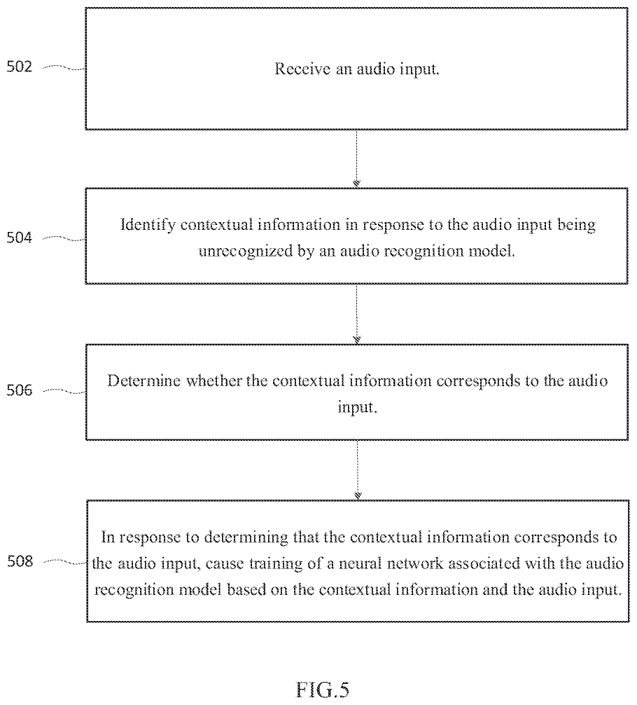

FIG. 5 is a flowchart for a method of analyzing contextual information, according to an embodiment. In operation 502, the system receives an audio input. In operation 504, the system identifies contextual information in response to the audio input being unrecognized by an audio recognition model. In operation 506, the system determines whether the contextual information corresponds to the audio input. In operation 508, in response to determining that the contextual information corresponds to the audio input, the system causes training of a neural network associated with the audio recognition model based on the contextual information and the audio input.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

What is claimed is:

1. A method, comprising:
receiving an audio input;
in response to the audio input being unrecognized by an audio recognition model, identifying contextual information;
determining whether the contextual information corresponds to the audio input; and
in response to determining that the contextual information corresponds to the audio input, causing training of a neural network associated with the audio recognition model based on the contextual information and the audio input.

2. The method of claim 1, wherein the audio input comprises a user speech utterance.

3. The method of claim 1, wherein the contextual information comprises text information.

4. The method of claim 3, wherein identifying contextual information comprises identifying the text information from at least one of a web browser, a contacts list, a messing application, or a map application.

5. The method of claim 1, wherein the contextual information is determined to correspond to audio input when the contextual information is acquired within a predetermined time period of receiving the audio input.

6. The method of claim 1, further comprising receiving an unrecognized audio textual input generated based on the unrecognized audio input.

7. The method of claim 6, wherein determining whether the contextual information corresponds to the audio input comprises determining a similarity score between the contextual information and the unrecognized audio textual input.

8. The method of claim 7, wherein the similarity score is determined based on an edit distance between the contextual information and the unrecognized audio textual input.

9. The method of claim 6, further comprising:
identifying a template in the unrecognized audio textual input; and
removing the identified template from the unrecognized audio textual input.

10. The method of claim 1, wherein training the neural network associated with the audio recognition model based on the contextual information and the audio input comprises:
storing the audio input and the contextual information;
extracting acoustic features from the received audio;
extracting textual features from the contextual information; and
updating model parameters of the audio recognition model based on the extracted acoustic features and extracted contextual information.

11. A system, comprising:
a processor; and
a memory storing instructions that, when executed, cause the processor to:
receive an audio input; and
in response to the audio input being unrecognized by an audio recognition model, identify contextual information; and
determine whether the contextual information corresponds to the audio input; and
in response to determining that the contextual information corresponds to the audio input, cause training of a neural network associated with the audio recognition model based on the contextual information and the audio input.

12. The system of claim 11, wherein the audio input comprises a user speech utterance.

13. The system of claim 11, wherein the contextual information comprises text information.

14. The system of claim 13, wherein the instructions, when executed, further cause the processor to identify contextual information by identifying the text information from at least one of a web browser, a contacts list, a messing application, or a map application.

15. The system of claim 11, wherein the contextual information is determined to correspond to audio input when the contextual information is acquired within a predetermined time period of receiving the audio input.

16. The system of claim 11, wherein the instructions, when executed, further cause the processor to receive an unrecognized audio textual input generated based on the unrecognized audio input.

17. The system of claim 16, wherein the instructions, when executed, further cause the processor to determine whether the contextual information corresponds to the audio input by determining a similarity score between the contextual information and the unrecognized audio textual input.

18. The system of claim 17, wherein the similarity score is determined based on an edit distance between the contextual information and the unrecognized audio textual input.

19. The system of claim 16, wherein the instructions, when executed, further cause the processor to:
identify a template in the unrecognized audio textual input; and
remove the identified template from the unrecognized audio textual input.

20. The system of claim 11, wherein training the neural network associated with the audio recognition model based on the contextual information and the audio input comprises:
storing the audio input and the contextual information;
extracting acoustic features from the received audio;
extracting textual features from the contextual information; and
updating model parameters of the audio recognition model based on the extracted acoustic features and extracted contextual information.
